(19) United States
(12) Patent Application Publication
(10) Pub. No.: US 2007/0078775 A1
(43) Pub. Date: Apr. 5, 2007

(54) System and method for preventing unauthorized use of digital works

(76) Inventors: Luis Miguel Huapaya, Ottawa (CA); Michael Prendergast, Ottawa (CA); Philippe Cadieux-Pelletier, Winnipeg (CA); Johann A. Seidenz, Ottawa (CA)

Correspondence Address: Ralph A. Dowell of DOWELL & DOWELL P.C., 2111 Eisenhower Ave, Suite 406, Alexandria, VA, 22314, US

(21) Appl. No.: 11/520,750

(22) Filed: Sep. 14, 2006

Related U.S. Application Data
(60) Provisional application No. 60/716,506, filed on Sep. 14, 2005.

(51) Int. Cl. G06Q 99/00

(52) U.S. Cl. 705/59

(57) ABSTRACT

A system and method for preventing unauthorized use of digital contents such as, but not limited to, music, movies, videos and computer games, henceforth referred to as “digital content” or “digital content”. The present invention protects the digital content by reformatting said digital content such that, the rendering context of the said digital content is lost. The rendering context that was removed by the reformatting process is then protected from unauthorized use such that only authorized users/computing devices can recover the rendering context and use it to render the protected digital content.

### CROSS-REFERENCE TO RELATED APPLICATION

This application claims the benefit of U.S. Provisional Patent Application No. 60/716,506, filed Sep. 14, 2005, which is hereby incorporated by reference in its entirety.

### FIELD OF THE INVENTION

The present invention relates to the management of digital rights, and more specifically, to a system and method used to prevent unauthorized users and/or computing devices from accessing and/or rendering protected digital content.

### BACKGROUND OF THE INVENTION

Almost all types of entertainment products in existence today can be digitized and distributed over the Internet. In most cases, it would be advantageous, from a business efficiency point of view, for authors, publishers and/or digital content providers (hereinafter referred to as “providers”) to leverage the efficiencies of Internet distribution in order to bring their digitized entertainment product to consumers.

Digital content, digital work, original content, original digital content or digitized entertainment product, as the terms are used interchangeably herein, are any collection of digitized information subject to distribution or transfer, including but not limited motion pictures, music and computer games. In some forms, the digital content will consist of a single computer file as is the case for a video file or a music file. In other forms, the digital content will consist of many computer files as is the case for a computer game. Said original content may originate from other non-digital forms (i.e. movies, music) and later converted to digital form within one or more computer files.

One of the biggest problems facing the entertainment industry today is the rampant piracy of digitized entertainment products which has grown by leaps and bounds due to the pervasiveness of personal computers, the widespread adoption of broadband connectivity in the home and the ever increasing availability of high speed wireless connectivity.

Efforts to resolve this piracy issue are not new and cover a wide range of solutions such as, but not limited to, copy protection schemes and product key authentication schemes. Of those anti-piracy solutions, those that belong to the field of Digital Rights Management (“DRM”), a field that is also referred to as Intellectual Property Rights Management (“IPRM”), Intellectual Rights Management (“IPM”) and Rights Management (“RM”), are the strongest and most promising anti-piracy solutions for the foreseeable future. Said DRM solutions use strong cryptographic methodologies to protect digital content. Although today's DRM solutions offer the best and strongest piracy protection available, they suffer from a series of weaknesses and deficiencies.

Most DRM solutions available today use the same basic approach whereas, the digital content that requires protection is encrypted and the cryptographic key required to decrypt it is itself protected using various mechanisms (hence the different types of DRM solutions). In most cases, the DRM solution protects the cryptographic key from unauthorized use, not the content itself. As long as the key is protected, the content is as well. Unfortunately, as is well known, hackers and other individuals searching for security vulnerabilities can determine how to remove the protection mechanism surrounding the cryptographic key relatively easily and quickly. As discussed herein, a hacker is defined as an individual, a group or any other entity dedicated to the task of removing anti-piracy mechanisms from protected digital content such that the said digital content may be distributed and used without permission (i.e. pirated). Once this is done, hackers can distribute a small “crack” program (i.e. small software application that removes piracy protection mechanisms from digital content) that can be easily distributed over the Internet and that can be used by the average consumer to unprotect the cryptographic key so that a digital product may be used without authorization.

Digital music and videos distributed over the Internet require a “player”, such as the Windows Media Player or the Apple iTunes player, in order to be rendered on a computing device. In most cases, the DRM protection mechanism used to protect music and videos files is centralized within the player itself. As such, once hackers manage to defeat the DRM protection mechanism embedded within the player, they have basically defeated the DRM protection for every current and future song and/or movie distributed over the Internet. This is known as a “hack once, pirate forever”(i.e. once the DRM protection mechanism within a central player is hacked, any and all digital that can be rendered by the said central player can now be rendered without permission). In most cases, hackers will then distribute a small crack program that the average consumer can use to remove the DRM protection from the player installed on their computing device.

Many anti-piracy solutions are not portable from one distribution mechanism to the next (i.e. CD, DVD, online downloads, etc.). This precludes having the anti-piracy solution protect digital content throughout its entire lifecycle (i.e. starts out on CD in retail and eventually moves to online distribution once the retail cycle ends). This forces digital content providers to use different digital content protection solutions at different stages in the lifecycle of their product, a practice which is at best, very cost inefficient. This can also become a problem for computer game software which is distributed through retail (i.e. CD or DVD) but then uses online distribution for patches and expansion packs. Unless the anti-piracy solution is flexible enough to function properly over different distribution mechanisms, the aforementioned scenario would prove to be a difficult one.

Some of the DRM solutions available on the market are a little stronger insofar as they distribute protected digital content using individualized encryption (i.e. the digital content is encrypted differently for each authorized user and/or computing device). However, all of these solutions require that the digital content be streamed down from a central Internet server which means that such solutions cannot be used for retail distribution (i.e. CD and DVD's) or for efficient peer to peer distribution over the Internet (i.e. streaming is less cost effective than peer to peer distribution). As such, a “streaming DRM” solution is often too restrictive for digital content providers to use.

In all of the DRM solutions currently available, the digital content is encrypted in its entirety. This can actually become a problem for portable computing devices that have limited battery life and limited processing bandwidth insofar as the entire content must be decrypted at runtime in order to be rendered, an operation which can prove to be very expensive for said portable computing devices.

With the exception of streaming based DRM solutions which are able to encrypt the digital content differently on a per consumer basis, most other DRM solution offered today distributes the exact same encrypted digital content. Apart from the issues already mentioned above, such an approach precludes the use of digital watermarking as a forensic mechanism to track down who is responsible for pirating content. With such digital watermarking technology, digital content providers would be capable of identifying and subsequently banning and/or disabling pirated instances of their entertainment products.

Some DRM solutions require the customer to be connected to the Internet in order to authenticate them every time they need to render the protected digital content. This is not desirable for customers that are on the move (i.e. airports, trains, etc.) where Internet connectivity is either expensive or impossible to find. DRM solutions in the computer games entertainment sector do not actually protect the entire digital content (i.e. the executable program and all associated data files) of the computer game but instead, prevent unauthorized users from running the executable program. As such, only the executable program is protected. Such a solution is unable to support revenue models that revolve around the monetization of content (i.e. sell extra levels, sell episodic content, etc.).

### SUMMARY OF THE INVENTION

In some embodiments, the invention comprises the following three parts:

1. Pre-distribution process. This process reformats the original digital content so that it may be freely distributed, through any means available, such that the distributed digital content is protected from unauthorized use. As used herein, “original” denotes a state of the digital content prior to the pre-distribution process. “Original” does not denote that the digital content is itself somehow new or unique.

2. Binding Process. This process binds the distributed digital content to an authorized computing device by storing the distributed digital content within a Secure Virtual File System (“SVFS”) on the authorized computing device such that it can only be rendered by the authorized computing device hosting the SVFS.

3. Runtime Access. Once the digital content is bound to an authorized computing device, it can be accessed at runtime using a runtime access system and methodology.

(1) Pre-Distribution Process

The pre-distribution process takes place usually, but not necessarily, before the original content is published (i.e. released to the public) and hence, is typically handled by the author or by the publisher. The purpose of the pre-distribution process is to take the original digital content and to fragment it into many smaller plain-text segments, hereto referred to as “unbound content” or “unbound segments”, without actually modifying the underlying digital content. By fragmenting the original content into many unbound segments, the original digital content's rendering context is removed. The rendering context, as discussed herein, is the relationship between each unbound segment as per its original location within the original content. Without a rendering context, it would be practically impossible to reassemble the unbound segments such that the original digital content is recreated.

Once unbound digital content is generated, a provider may distribute it through any means (i.e. retail distribution using CD or DVD media, online distribution using streaming, direct downloads or peer to peer distribution).

Since unbound content basically consists of many small unbound segments, whereupon an exemplary file size for an unbound segment may be 262,144 bytes, it is positioned for optimal distribution over distributed (i.e. peer to peer) networks whereupon a single computing device may receive different unbound segments from many different other computing devices at the same time. This would present publishers with a cost efficient distribution mechanism since, in some cases, almost all of the unbound segments being distributed would in fact be distributed by computing devices that belong to customers instead of computing devices that belong to the publisher. As such, the publisher could distribute unbound segments in large volumes using fewer servers and requiring less bandwidth. Moreover, each unbound segment file could be named such that the segment name itself could be formatted such that the name itself contains searchable metadata that makes it easy for the unbound segments to be freely distributed over public peer to peer networks.

The pre-distribution process also involves generating a dictionary of mapping information, hereinafter referred to as the “mapping information”, for the generated unbound segments and how they relate to each other as per their location within the original content. This mapping information basically represents the rendering context that was removed from the original digital content when it was fragmented. Different embodiments may store additional information within the mapping information. Such is the case for digital content that contains multiple files and folder such as computer games, whereas information about the structure of the file system (i.e. file names, folders, access rights, etc.) will also be stored within the mapping information.

Unlike unbound content, mapping information will not be freely distributed but instead, will be kept secret. The mapping information will be used by an Internet based license server, as described below.

Encryption of the original digital content is generally not required before distribution. In some embodiments, all of the original digital content will be shipped, though without the rendering context that ties all of the unbound content together.

In one embodiment, the pre-distribution process consists of a single software application (“pre-distribution process tool”) that not only fragments the original plain-text digital content into unbound segments that are stored within their own separate files, and generates the associated mapping information, but the software application also helps the provider associate additional metadata such as, but not limited to, authentication and distribution rules, web metadata (i.e. Title, Description, Cover Art, etc.) and market metadata such as Price, Tax Rules, etc. Moreover, in this embodiment, the pre-distribution process tool would also destroy (“salt”) critical data within the original plain-text content before it is fragmented into unbound segments. The mapping information would contain additional information that would allow for the salted portions of affected unbound segments to be reverted back to their original unsalted values.

As mentioned above, once the pre-distribution process is completed, the provider can then choose to distribute the unbound content using conventional distribution mechanisms such as CD, DVD or online distribution. By themselves, the disparate plain-text unbound segments are completely unusable since it would be computationally impractical to determine how to put each separate unbound segment back together such that the original plain-text digital content is reassembled correctly. For example, a small 3 megabyte (3,145,728 bytes) music file fragmented into 24 equal segments of 128 kilobyte (131,072 bytes) would have 24 factorial (620,448,401,733,239,439,360,000) different ways to be reassembled.

(2) Binding Process

As previously described, the protected digital content is distributed to users as unbound content using conventional distribution mechanisms.

Before the distributed digital content can be rendered by an authorized user and/or computing device (“authorized entity”), it must first be bound to an authorized computing device. The main purpose of this binding process is to reassemble the unbound content (i.e. what is distributed) within one or more SVFS containers. The unbound content will be reassembled such that it is generally not reassembled the same way twice, from one authorized entity to another.

The binding process can only take place once a user and or computing device has been authorized. In some embodiments, the invention does not actually specify how a user and/or computing device becomes authorized. Authentication processes known in the art can be used. In some embodiments, it is possible for the provider to simultaneously use several different authentication mechanisms (i.e. if the digital product is sold in retail, a product key is used for authorization but if the digital product is sold online a credit card is used for authorization). Once the user and/or computing device is authorized (“authorized entity”), the binding process can start.

In some embodiments, the binding process requires that the authorized entity connect to an Internet based license server. Once connected and authenticated, the license server will provide the authorized entity with a set of instructions referred to herein as the “binding bundle” which contain, but is not limited to:

i. Reassembly rules that contain detailed information (i.e. name, size in bytes, CRC, etc.) about the unbound segments and how they should be reassembled into one or more SVFS containers. Once the unbound segments are reassembled within one or more SVFS containers, they become bound segments. The unbound segments are not reassembled such that the original content is reconstructed but instead, each unbound segment is reassembled in a quasi-random order within the one or more SVFS containers such that no two authorized entities will end up with identically reassembled unbound content. Each authorized entity may be given a different set of reassembly rules and as such, the unbound segments are reassembled differently for every authorized entity. The digital content may therefore be individualized on a per computing device basis, and the unbound segments are reassembled in such a way as to serve as a digital fingerprint that would identify the authorized entity. The digital content would not be modified and as such, the digital fingerprint will not be capable of removal. Moreover, in some embodiments of the invention, the reassembly rules contained within the binding bundle will be made up of data “A”, such that “A” is computing device sensitive which means that the actual relevant data “B” required to bind the unbound segments to the computing device is derived from computing device specific settings “C” using a function “F” such that F(A, C)=B. Said function “F” would end up yielding the wrong results “B” should it end up being used on a computing device other than the authorized computing device. Hereinafter, data “A” will be referred to as “hardware sensitive” data. Prior art often refers to hardware sensitization as machine binding or non-portability. Refer to FIG. 6 and FIG. 7 for illustrative examples involving hardware sensitive data.

ii. File Allocation Table (“file index”). The reassembly rules described above do not actually contain any information pertaining to how each bound segments relate to each other as per their original position within the original digital content. In order for the authorized entity to properly render the protected digital content, information regarding how the bound segments relate to each other as per their original position within the original digital content must be provided (i.e. the rendering context). This is achieved using the file index. As per the reassembly rules, each authorized entity will receive a file index that may be hardware sensitive. In some embodiments, the individualized file index will not only contain how each bound segments relate to each other, but it may also contain additional relevant information as stored within the mapping information that was generated by the pre-distribution process.

iii. Executable code (“runtime binaries”) that contains a portion of the Digital Rights Management code required to render the protected content. To minimize the risk that the “hack once, pirate forever” exploit cannot be used, some of the DRM protection mechanism is part of the protected digital content and not just part of the underlying player and/or software application required to render the protected content.

iv. Relevant cryptographic keys. In some embodiments, all or part of the data will be encrypted within binding bundle such that it would be difficult for hackers to access the underlying information.

Along with the binding bundle, the license server will also download a special setup program responsible for interpreting the binding bundle in order to assemble the unbound segments, secure the file index, secure the runtime binaries and secure the relevant cryptographic keys.

In some embodiments, once the binding process is over, the authorized computing device will contain:

i. Setup program;

ii. One or more SVFS containers which are made up, at the very least, of bound segments;

iii. Secured and individualized reassembly rules and possibly associated cryptographic keys;

iv. Secured and individualized file index and possibly associated cryptographic keys; and

v. Secured and runtime binaries and possible associated cryptographic keys.

(3) Runtime Access

Once the binding process is completed, the authorized entity is now in a position to render the protected digital content.

From hereon, the authorized entity will only need use a runtime access portion since the first two parts (i.e. Pre-distribution Process and Binding Process) have now been completed.

As per all digitized entertainment content, an application program (“executable”) is required in order to render the entertainment content on a computing device. The executable may consist of a central media player that can render songs and videos, such as the Windows Media Player™, or a custom made application program such as a computer game.

In order for digital content that is protected in the manner described herein, the executable program or associated binaries must contain special code that is able to bootstrap the runtime binaries which in turn will be able to retrieve the protected digital content so that the executable program may render it.

In one embodiment of the invention, the runtime binaries will be stored in encrypted form within one of the SVFS containers. In order to make it harder for hackers to find the runtime binaries, the location of the runtime binaries and associated cryptographic key(s) will derive from a function that is hardware sensitive, hence tying their location to a specific computing device. Other embodiments of the invention may use different methods to secure the runtime binaries and associated cryptographic keys.

Once loaded into memory, the runtime binaries will replace some of the traditional OS based file system API function calls (i.e. OpenFile( ), ReadFile( ), SeekFile( ), etc.) called from the executable program with equivalent API function calls that use the SVFS containers and file index information to establish a secure virtual file system. In doing so, the executable program can now gain access to the protected digital content through the runtime binaries by using what seems like traditional OS based file system API function calls. Once the runtime binaries have replaced the traditional OS based file system API function calls, they will be required to load the individualized file index into memory.

In one embodiment, the individualized file index will be stored in encrypted form within one of the SVFS containers. As per the runtime binaries, the location of the individualized file index and associated cryptographic keys will derive from a hardware sensitive function. Other embodiments of the invention may use different methods to secure the individualized file index and associated cryptographic keys.

The underlying file index data consist of, but is not limited to, a sequential array of bound segment information which denotes the starting offset and size in bytes of each bound segment as sequentially ordered within the original plain-text digital content. Reading each byte of each bound segment as sequenced within the array will yield the same results as reading the original plain-text digital content.

In some embodiments, the file index data may also contain additional information as per the additional information that may have been stored within the mapping information that was generated by the pre-distribution process.

According to one aspect of the present invention, there is provided a method for protecting digital content from unauthorized use comprising the steps of: fragmenting the digital content into a plurality of plain text segments; to form unbound content so that the rendering context of each plain text segment in the digital content is removed; and generating mapping information containing information as to how the plain text segments relate to each other as per their original location within the digital content.

According to another aspect of the present invention, there is provided a method of managing digital rights of digital content at an end user computing device comprising the steps of: receiving digital content in the form of a plurality of plain text segments without a rendering content; receiving an end user computing device reassembly rules for the plain text segments, and a file allocation table containing rendering context for each plain text segment, and using the reassembly rules and file allocation table to uniquely bind the plain text segments to the end user computing device thereby forming bound content.

### BRIEF DESCRIPTION OF THE DRAWINGS

The structure and function of the invention is best understood with reference to the included drawings, which may be described as follows:

FIG. 1 is a schematic diagram of a general purpose computing device in the form of a conventional personal computer;

FIG. 2 is a flow chart of the steps original digital content undergoes from authoring to runtime in accordance with one embodiment of the invention;

FIG. 3 is a schematic diagram illustrating the pre-distribution process and resulting output;

FIG. 4 is a schematic diagram illustrating the salting process used within the pre-distribution process just prior to the fragmentation process illustrated in FIG. 5;

FIG. 5 is a schematic diagram illustrating the fragmentation process used within the pre-distribution process;

FIG. 6 is a schematic diagram illustrating non-reversible, hardware sensitive data;

FIG. 7 is a schematic diagram illustrating reversible, hardware sensitive data.

FIG. 8 is a schematic diagram illustrating the attributes that precede the binding process in some embodiments;

FIG. 9 is a schematic diagram illustrating how an individualized binding bundle is issued by a license server for a specific computing device in some embodiments;

FIG. 10 is a schematic diagram illustrating the attributes of the binding process in some embodiments;

FIG. 11 is a schematic diagram illustrating the core functionality of the reassembly process in some embodiments; and

FIG. 12 is a schematic diagram illustrating one example of how the runtime process uses the File Allocation Table in order to access the bound content.

### DETAILED DESCRIPTION OF THE PREFERRED EMBODIMENTS

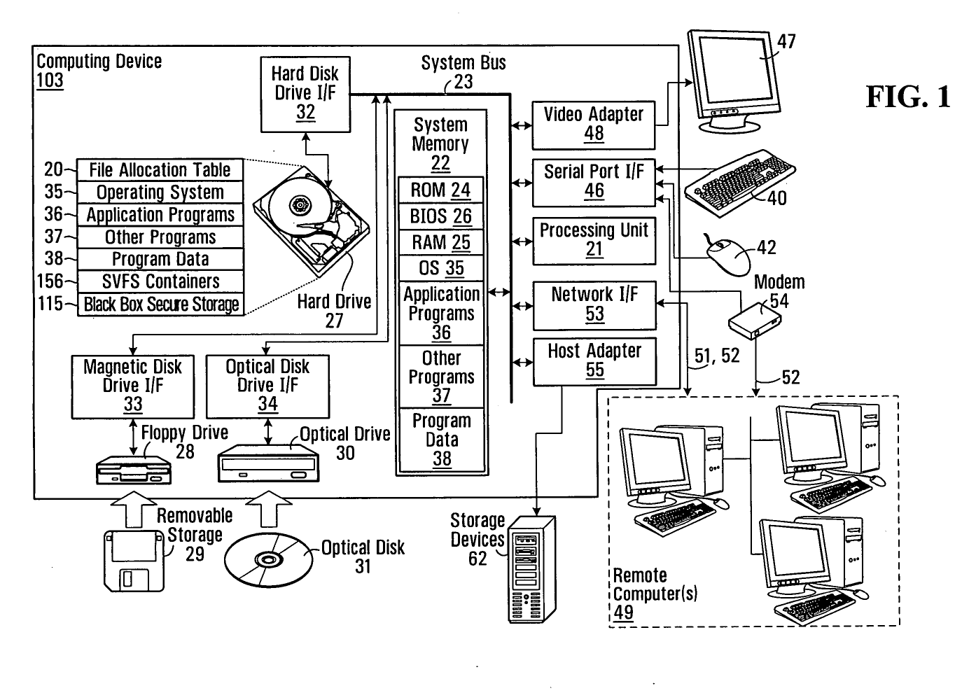

FIG. 1 provides a brief general description of a suitable computing environment in which the invention may be implemented in some embodiments.

Although not required, the invention will be described in the general context of a data flow diagram representing the flow of data over a distributed computing system of networked personal computers (i.e. computing devices 103). Those skilled in the art will appreciate that the invention may be practiced with other computer system configurations, including hand-held devices, multi-processor systems, microprocessor-based or programmable consumer electronics, network PCs, minicomputers, mainframe computers and the like.

As shown in FIG. 1, an exemplary system for implementing the invention includes a general purpose computing device 103 in the form of a conventional personal computer or the like, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system 26 (BIOS), containing the basic routines that help to transfer information between elements within the personal computer, such as during start-up, is stored in ROM 24. The personal computer may further include a hard disk drive 27, a magnetic disk drive 28 for reading from or writing to a removable magnetic disk 29, and an optical disk drive 30 for reading from or writing to a removable optical disk 31 such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the personal computer. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37, program data 38 and a File Allocation Table 20 (“FAT”). A user may enter commands and information into the personal computer through input devices such as a keyboard 40 or a pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port, universal serial bus (USB), or a 1394 high-speed serial port. A monitor 47 or other type of display device is also connected to the system bus 23 via an interface, such as a video adapter 48. In addition to the monitor 47, personal computers typically include other peripheral output devices (not shown), such as speakers and printers.

The personal computer may operate in a networked environment using logical connections to one or more remote computers 49. The remote computers 49 may be another personal computer, a server, a router, a network PC, a peer device or other common network node, and typically includes many or all of the elements described above relative to the personal computer. The logical connections depicted in FIG. 1 include a local area network (LAN) 51 and a wide area network (WAN) 52. Such networking environments are commonplace in offices, enterprise-wide computer networks, Intranets and the Internet.

When used in a LAN 51 or WAN 52 networking environment, the personal computer is connected through a network interface or adapter 53, a modem 54 or other means.

The modem 54, which may be internal or external, is connected to the system bus 23 via the serial port interface 46. In a networked environment, program modules depicted relative to the personal computer, or portions thereof, may be stored in the remote memory storage device. It will be appreciated that the network connections shown are exemplary and other means of establishing a communications link between the computers may be used.

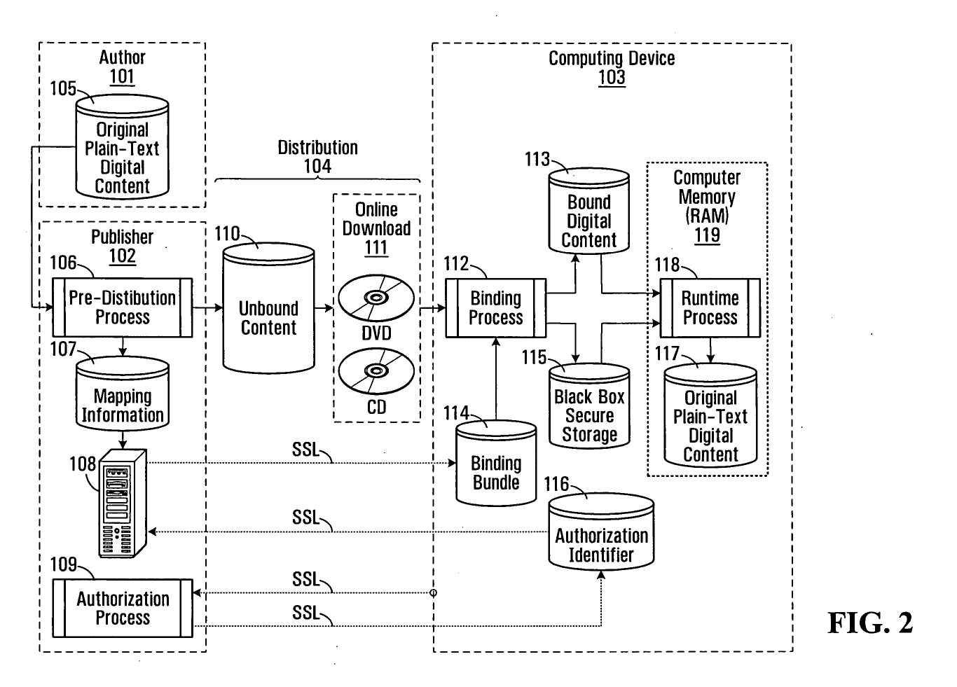

Shown in FIG. 2 is original plain-text digital content (“original content”) 105 which may consist of, but is not limited to, an entertainment product such as a song, a motion picture, a television program or a computer game, which is created by an author 101. Said original digital content 105 may be composed of one or more computer files. Audio and video works are examples of original digital content 105 that would consist of a single computer file such as an MP3 or WMA formatted file for audio and MOV, AVI or WMV formatted file for video. Computer games are examples of original digital content 105 that would consist of several computer files, usually numbering in the hundreds.

Once the content creation process is completed, the said original digital content 105 is given to the publisher 102 whereupon the publisher 102 is defined as the person, group and/or corporate entity responsible for the distribution of the digital content. The publisher 102 will run the original digital content 105 through the pre-distribution process 106 which generates unbound content 110 that consists of almost the same plain-text digital content as the original digital content 105 but without the required rendering context needed to render the digital content. Said unbound content 110 can then be distributed through any means desired 111 such as CD, DVD or online distribution without fear that the unbound content 110 could be reassembled properly in order to recreate the original digital content 105. The pre-distribution process 106 also generates the mapping information 107 that consist of the rendering context that was removed by the pre-distribution process 106. Said mapping information 107 is then forwarded to an Internet based license server 108 so that it may be used to generate individualized binding bundle 114 as requested by an authenticated computing device 103.

The authentication process 109 is typically but not necessarily handled by the publisher 102. In general, the invention does not specify what this authentication process should consist of, but it does require the authentication process to generate an authentication identifier 116 needed so that the authenticated computing device 103 may be able to access the license server 108.

The distributed unbound content 110 is unusable since it would be nearly impossible to reconstitute the rendering context that was removed from the original digital content 105 by the pre-distribution process 106. In order for the unbound content 110 to become usable again, it must be bound to a computing device 103, a task that will be accomplished by the binding process 112. The authorization process 109 will give a computing device 103 an authorization identifier 116 required to connect to an Internet based license server 108 which will issue the computing device 103 a binding bundle 114 required for the binding process 112 to take the unbound content 110 and reassemble it into bound digital content 113. Critical information required to access the bound content 113 is secured within a black box secure storage mechanism 115 such the said critical individualized information cannot be moved and/or modified.

Once the binding process 112 is completed, the bound content 113 coupled with the critical individualized information stored within the black box secure storage mechanism 115 are used by the runtime process 118 in order to recreate and access the original digital content 105.

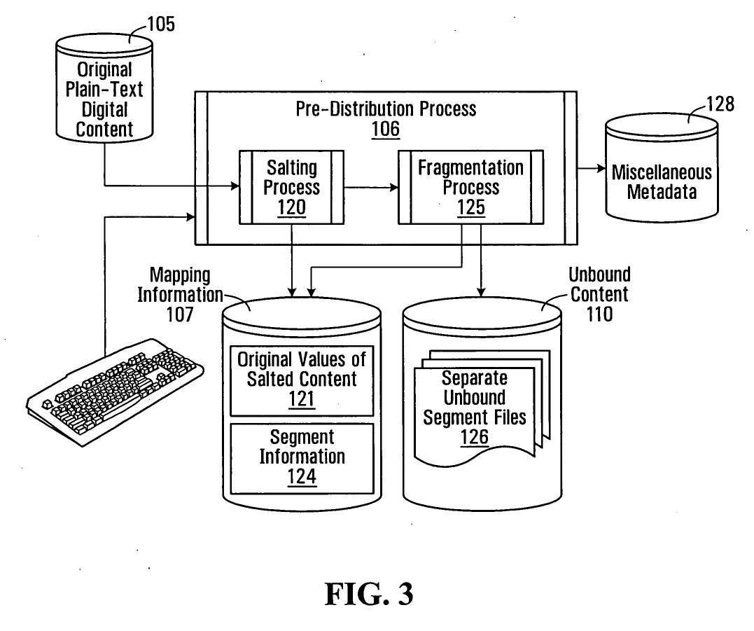

FIG. 3 is a schematic diagram illustrating the pre-distribution process and resulting output in some embodiments.

The main purpose of the pre-distribution process 106 is to reformat the original digital content 105 such that the resulting unbound content 110 is totally unusable until it becomes bound to an authorized computing device 103. In some embodiments, the original digital content 105 is first treated by an optional salting process 120 before being fragmented into separate unbound segment files 126 by the fragmentation process 125.

The purpose of the salting process 120, which may or may not be implemented by particular embodiments, is to identify and then destroy small but critical pieces of data within the original digital content 105. Prior to being destroyed, the original values of the salted content 121 are saved within the mapping information 105. The goal of the optional salting process 120 is to make it even harder for the underlying digital content 105 to be used without authorization since without those critical pieces of data 121 that have been salted, it will, in general, be impossible to render the salted digital content or the resulting digital content will be improperly rendered.

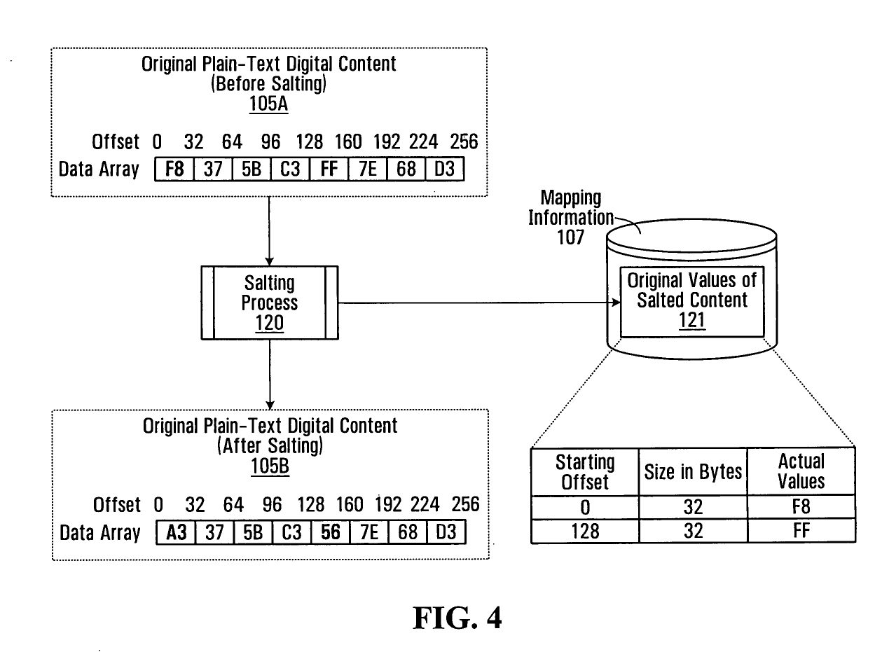

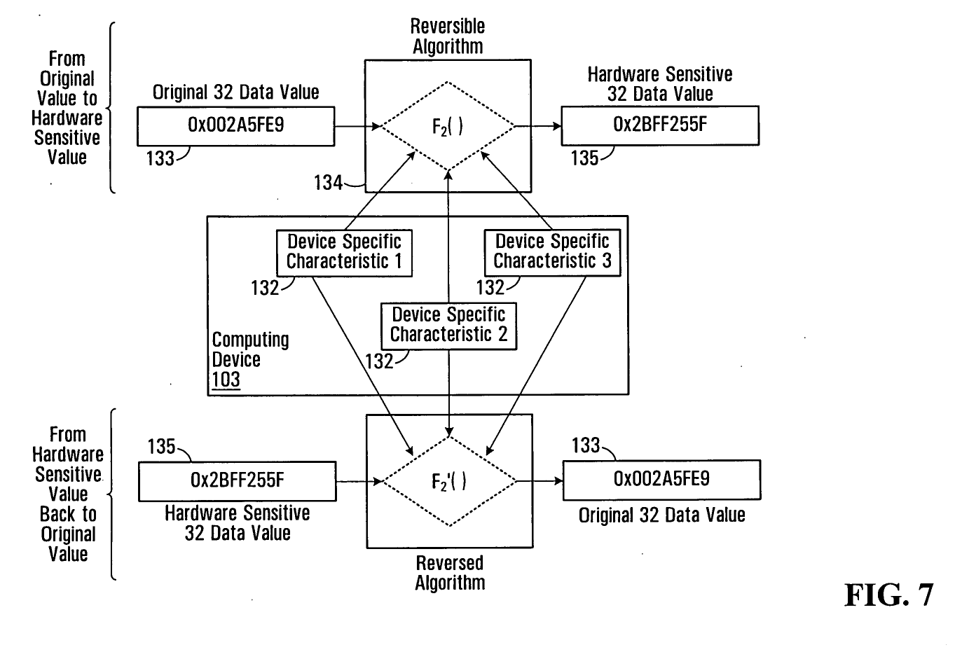

Once salted (if salted) the original digital content 105 will be treated by the fragmentation process 125 whereas the original digital content 105 will be fragmented (see FIG. 4) into separate unbound segment files 126 whereupon each file basically contains a relating small portion of the original digital content 105 (salted or not) in plain-text form. The goal of the fragmentation process 125 (see FIG. 4) is to remove the rendering context from the original digital content 105 such that the resulting unbound content 110, now devoid of any rendering context, is unusable for its desired purpose. The rendering context is defined as the information needed to reassemble each separate unbound segment file 126 in the proper order such that the original digital content 105 is reconstituted. As such, the unbound content 110 can henceforth be freely distributed through conventional means 111 because it cannot be used until it is bound to an authorized computing device 103 (see FIG. 1 and FIG. 7).

The pre-distribution process 106 produces two key datasets: mapping information 107 dataset, which is kept secret by the publisher 102, and the unbound content 110 which will be freely distributed to the public. The mapping information 107 can be augmented with additional metadata by publisher input 127. The pre-distribution process 106 can also produce a third optional dataset that consists of miscellaneous metadata 128 whereupon the information contained therein may include such information as web metadata such as product title, product description, cover art, pricing information, etc. In one embodiment, a single software application would be responsible for all aspects of the pre-distribution process 106. This approach would help centralize all activities relating to the packaging and distribution of a digital work (i.e. original digital content 105).

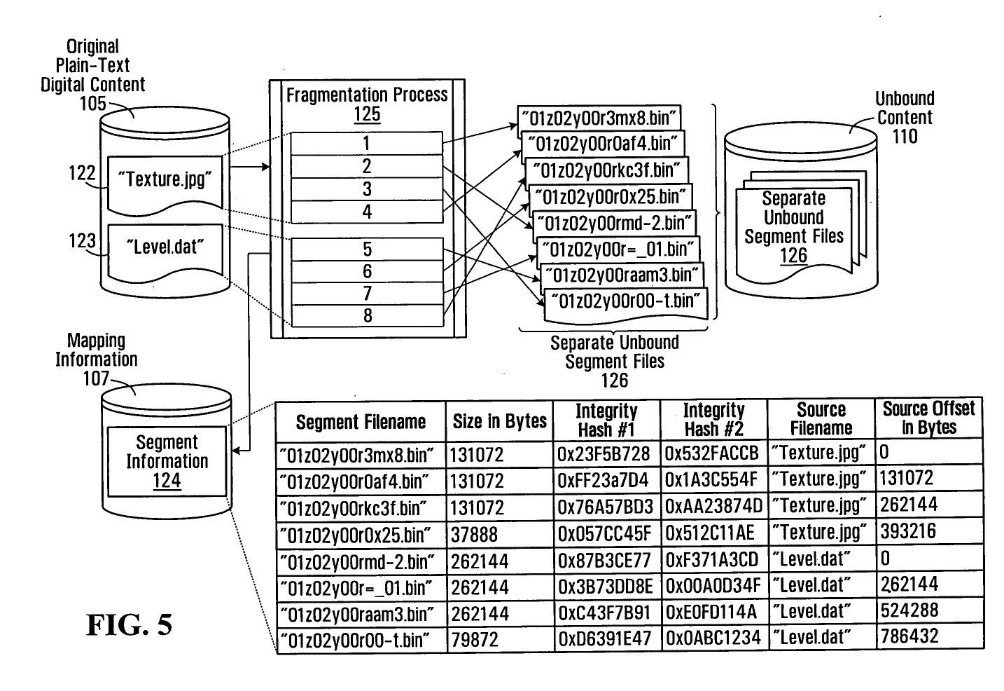

FIG. 4 is a schematic diagram illustrating the salting process used within the pre-distribution process just prior to the fragmentation process illustrated in FIG. 5.

The salting process 120 is used to pollute the original digital content 105 (a) such that the resulting original digital content 105 (b) is almost identical except that critical pieces of information within the original digital content 105 have been substituted with meaningless data. In order to understand the usefulness of the salting process 120, one must understand that many different types of computer files are specifically structured and that small but critical pieces of data within those computer files are needed to properly understand the said specific structure. For example, static digital images such as a JPEG, GIF or BMP computer files can be totally disabled simply by polluting the file header which usually span the first 32 bytes (or so) of the computer file. As such, a 61,440 byte long digital image can be disabled by simply destroying the first 32 bytes (i.e. 0.06%) of the computer file.

Moreover, the salting process 120 also benefits from the fact that critical data contained within widely used computer file formats can act as easily detectable markers and as such, salting the said critical data will help prevent malicious attempts to detect structure in the data. The importance of this benefit will become clear once the binding process 112 and how unbound content 110 ends up getting bound by storing each unbound segment 126 together within a SVFS container 156. If the easily detectable markers contained within the critical data of widely used computer file formats were to remain unsalted, it would be easier to detect the data structure of a SVFS container 156. By salting the said critical data, it becomes much more difficult to determine the structure of a SVFS container 156.

FIG. 5 is a schematic diagram illustrating the fragmentation process used within the pre-distribution process in some embodiments.

Through fragmentation process 125, the original digital content 105 is protected by being fragmented into a plurality of many smaller plain-text segments 126 (i.e. unbound segment files 126 or unbound content 110) each of which consists of, but is not limited to, separate computer files. The unbound content 110 generally contains the same plain-text data as the original digital content 105, but it does not have the rendering context required to properly render it. It would be computationally unfeasible for someone to figure out how each separate unbound segment 126 relate to each other as per their original position within the original digital content 105.

The example of FIG. 4 illustrates a scenario whereas the original digital content 105 consists of two separate computer files: “Texture.jpg” 122 is a 431,104 byte long computer file and “Level.dat” 123 is a 866,304 byte long computer file. Each file 122 and 123 is fragmented by the fragmentation process 125 into four different segments, thus resulting in a total of eight segments, each of which is stored into its own separate unbound segment file 126. Each separate unbound segment file 126 is given a pseudo-random file name that does not suggest at how each separate unbound segment file 126 relate to each other as per their original within the original digital content 105. For each separate unbound segment file 126 generated, one record of data is added to the segment information 124 dataset within the mapping information 107. As demonstrated in FIG. 1, this mapping information 107 is used by license server 108 in order to generate a binding bundle 114 that is needed in order to bind the unbound content 110 to an authorized computing device 103.

The core segment information 124 can vary depending on the composition of the original digital content 105. In the illustrated example of FIG. 4, the original digital content 105 is made up of several files (in this case two). As such, the segment information 124 must contain data points within each record that shows the provenance of each separate unbound segment file 126. In cases where the original digital content 105 is only made up of a single file, then each segment information 124 record would not be required to track its provenance as previously stated. Segment information 124 can be augmented by many useful data points such as version information, access rights, etc. That being said, each segment information 124 record must at the very least contain information about the name of the separate segment file 126, the size of the segment and the offset of the segment within the original digital content 105.

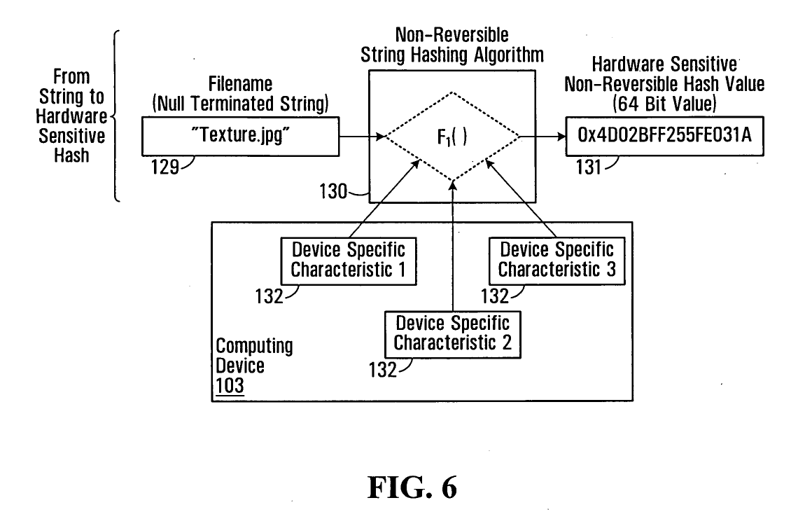

FIG. 6 is a detailed diagram illustrating the concept of non-reversible, hardware sensitive data.

The processes described herein make extensive use of non-reversible hardware sensitive data which is henceforth defined as data 129 which is converted using a non-reversible algorithm 130 (i.e. once converted, the resulting data cannot be used to recompute the original data) such that the resulting data 131 is produced by an algorithm F₁( ) 130 that uses the original data 129 in combination with one or more device specific characteristic 132.

In the illustrated example, original data 129 embodied by null terminated string is converted by a non-reversible algorithm F₁( ) 130 that uses the original data 129 as well as one or more device specific characteristic 132 as inputs and produces a single data output that is now hardware sensitive, embodied within by a 64 bit hash value 131. One skilled in the art would easily realize that the resulting 64 bit hash value 131 could not be reversed through any means in order to recover the original data 129.

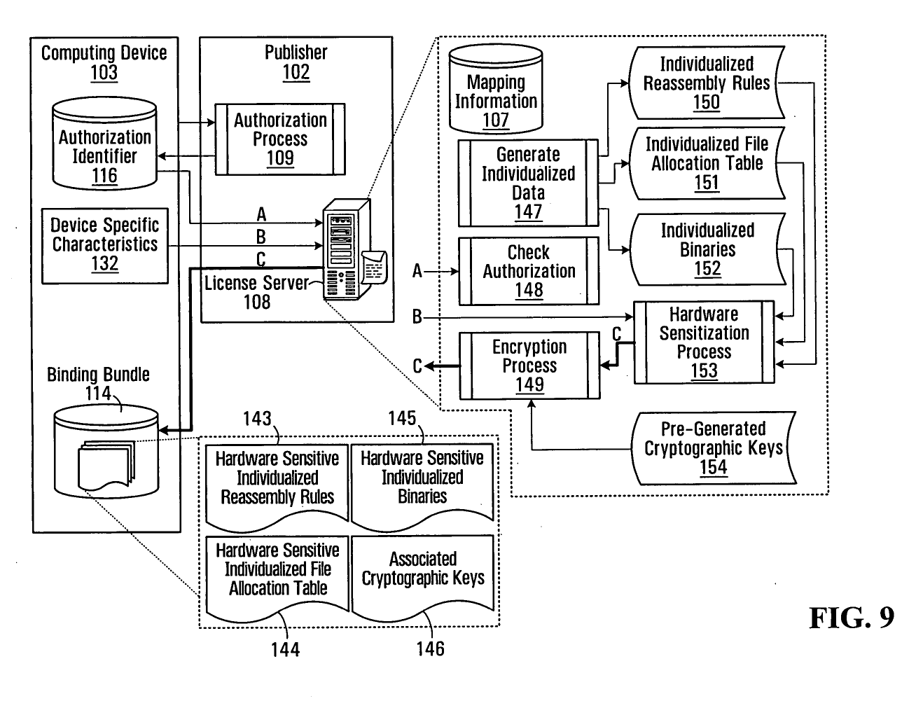

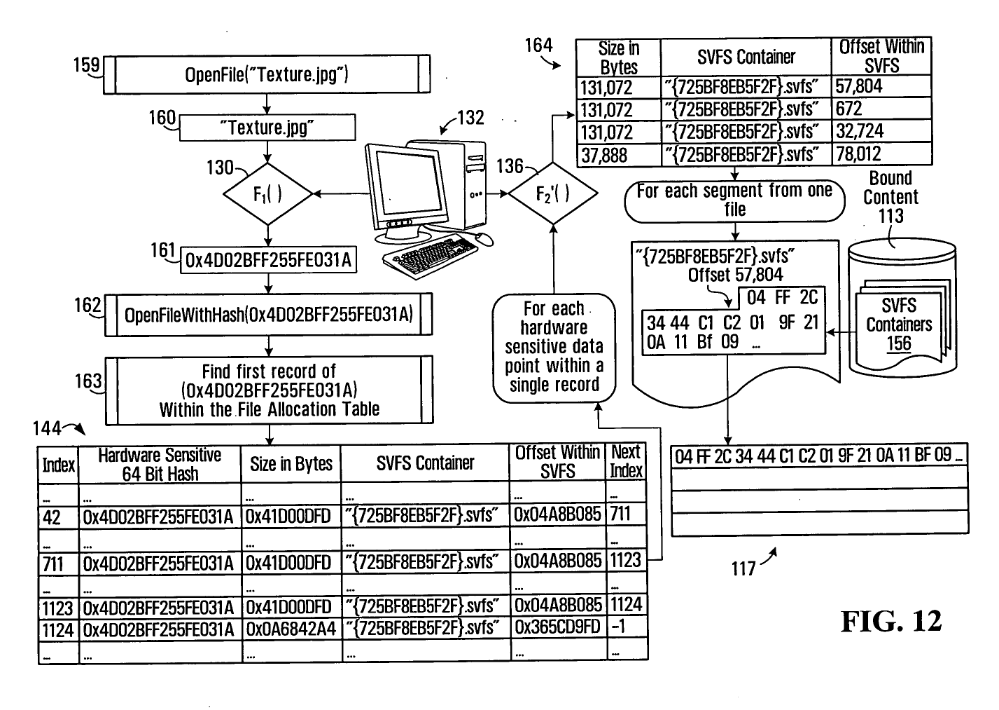

The processes described herein make specific use of such non-reversible hardware sensitive data when dealing with the encoding of filenames within the individualized File Allocation Table 144 (see FIG. 9) which is stored within the black box secure storage 115 (see FIG. 9). FIG. 12 illustrates how the function call OpenFile(“Texture.jpg”) derives the appropriate hardware sensitive hash value at runtime in order to gain access to the underlying File Allocation Table 144 entry. Only on the computing device 103 for which the File Allocation Table 144 was encoded would this work.

FIG. 7 is a detailed diagram illustrating reversible, hardware sensitive data.

Reversible, hardware sensitive data 133 is analogous to non-reversible hardware sensitive data 129 insofar as original data 133 is converted into hardware sensitive data 135 by an algorithm F₂( ) 134 except that in this case, the hardware sensitive data 135 can be converted back into the original data 133 by an algorithm F₂′( ) by using the same device specific characteristics 132 that were used by F₂( ) when converting the original data 133 into hardware sensitive data 135.

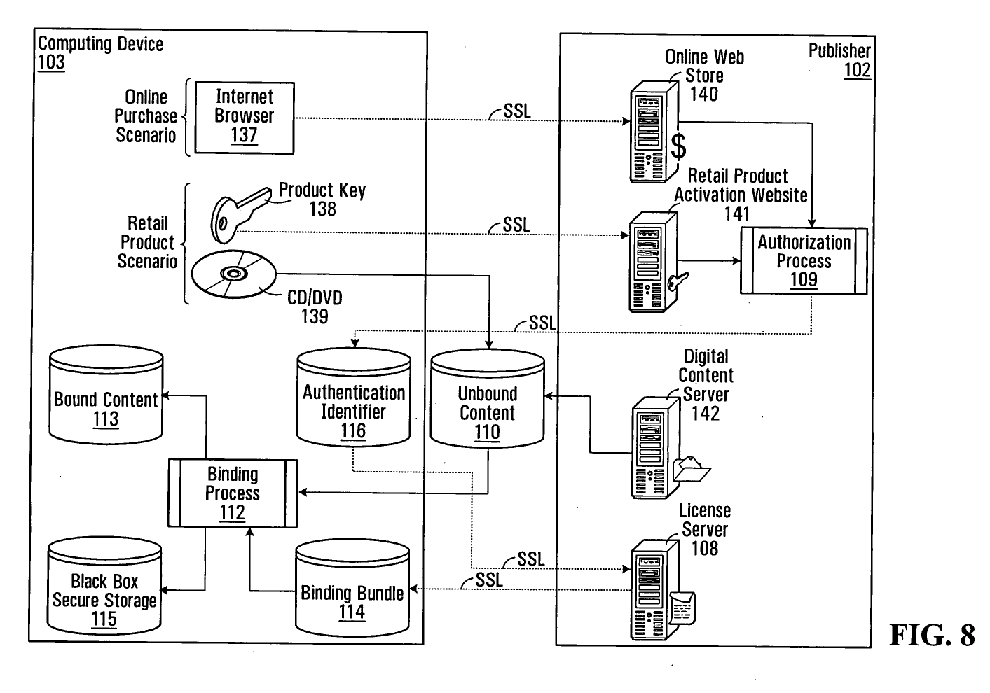

FIG. 8 is a top level diagram illustrating the critical attributes that precede the binding process 112 which takes unbound content 110 that is unusable and turns it into bound content 113 which can only be used on the computing device 103 on which it has been bound in some embodiments.

Original digital content 105 is distributed 102 through conventional 111 (see FIG. 2) in the form of unbound content 110 which may consist of separate unbound segment files 126 (see FIG. 5). By itself, unbound content 110 is unusable since it would be practically impossible for anyone to take unbound content 110 and to combine it back such that original digital content 105 is properly reconstituted. For example, if a 3,145,728 byte long music file were to be fragmented and distributed as 24 separate unbound segment files of 131,072 bytes each, there would be 24! (24 factorial=620,448,401,733,239,439,360, 000) different ways to recombine these 24 separate unbound segment files.

In order for unbound content 110 to become usable, it must be converted into bound content 113 on a computing device 103 that has been previously authorized 109 to bind the said unbound content 110.

The binding process 112 turns unbound content 110 into bound content 113 and related secure metadata that is stored within a black box secure storage mechanism 115. In order for the binding process 112 to take place on a specific computing device 103, license server 108 must issue the computing device 103 an individualized binding bundle 114 which acts as a set of instructions on how to reconstitute the unbound content 110 into bound content 113 for the specific computing device 103 for which the binding bundle 114 has been issued. The individualized binding bundle 114 also contains instructions on how to render the bound content 113 such that the original content 110 is reconstituted at runtime (see FIG. 8).

However, before a license server 108 can issue an individualized binding bundle 114 to a specific computing device 103, computing device 103 must first be issued an authorization identifier 116 which acts as a key to access the license server 108. The authorization identifier 116 is issued by the authorization process 109 which can be anything the publisher 102 wants it to be. In the particular illustrative embodiment of FIG. 8, the authorization process 109 can either take place within an online web store 140 where credit card information is collected and used to authorize the transaction or within a retail product activation web site 141 where a product key (usually shipped within the retail box of a software product) is used to activate and authorize the binding process 112 for a specific computing device 103. Regardless of what the authorization process 109 is, if successful, it must issue an authorization identifier 116 which is then used to gain access to a license server 108 which then issues the binding bundle required by the binding process 112 in order to turn unbound content 110 into bound content 113.

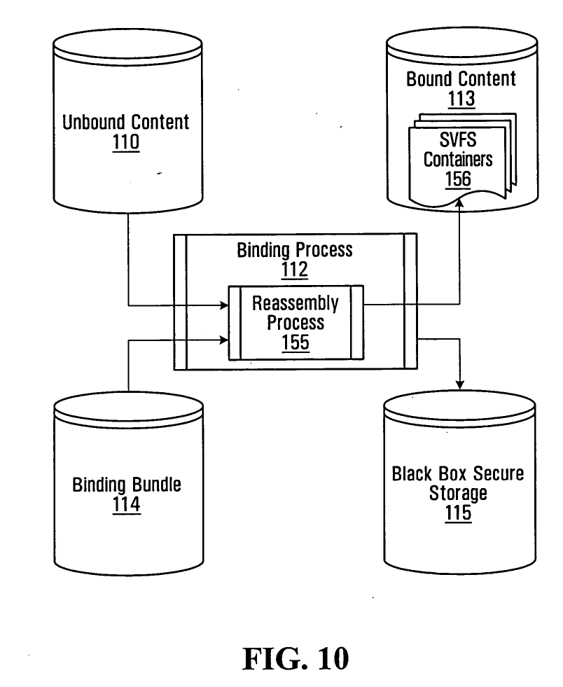

FIGS. 9 and 10 will further illustrate the critical attributes of the binding process 112. FIG. 9 is a schematic diagram that illustrates how an individualized binding bundle 114 is issued by a license server 108 for a specific computing device 103 in some embodiments.

The binding bundle 114 is an aggregate containing at least two (2) critical datasets and can optionally contain other datasets such as the one listed below:

i. Reassembly rules 143 (individualized and hardware sensitive in some embodiments).

ii. File Allocation Table 144 (individualized and hardware sensitive in some embodiments).

iii. Binaries 145 (individualized and hardware sensitive in some embodiments).

iv. Cryptographic keys 146. Different embodiments of the invention may or may not require cryptographic keys.

v. An authorization identifier 116, which may consist of but is not limited to a digitally signed unique identifier, is used to gain access to a license server 108 which is hosted by the publisher 102 (or a subordinate thereof). Once the authorization identifier 116 is checked 148 and access to the license server 108 is granted, the process of generating individualized data 147 begins.

In some embodiments, the license server 108 generates:

i. Individualized and hardware sensitive reassembly rules 150 that more or less guarantee that different computing devices 103 will reassemble the unbound content 110 into bound content 113 such that the bound content is unique to the computing device 103.

ii. Individualized and hardware sensitive File Allocation Table 151. There is a symbiosis between the reassembly rules 150 and the File Allocation Table 151 whereupon how and where unbound content 110 is stored within the bound content 113 (and more specifically the SVFS containers 156) entirely depends on where each unbound segments files 126 which belong to the file (i.e. 122 or 123) are stored within the SVFS containers 156.

In this illustrative embodiment of the invention, license server 108 will also generate:

i. Individualized and hardware sensitive binaries 152. Said binaries 152 represent executable code used to access the bound content 113 at runtime 118. For example, the said binaries 152 may be a Dynamic Link Library (.DLL) on a Microsoft Windows™ Operating System which is dynamically loaded by the underlying application executable in order to be able to access the protected digital content (i.e. bound content 113).

ii. Cryptographic Keys. If one or more datasets (i.e. 143, 144 & 145) within the binding bundle 114 are encrypted 149 by the license server 108 prior to being transmitted to a computing device 103, then the binding bundle must also contain the related cryptographic keys 154 that are required for the said computing device 103 to access the encrypted datasets (i.e. 143, 144 & 145). How these cryptographic keys are secured within the binding bundle 114 may vary from one embodiment of the invention to another.

iii. The licenser server 108 uses the mapping information 107 generated by the pre-distribution process 106 (see FIG. 1) in order to generate the individualized reassembly rules 150, the individualized File Allocation Table 151 and the runtime binaries (i.e. individualized binaries 152). In some embodiments of the invention, it would be advantageous for the individualized datasets (i.e. 143, 144 & 145) to be pre-generated long before they are ever used. This speeds up the time required for the license server 108 to issue a binding bundle 114 once a computing device 103 requests it.

FIG. 10 is a top level diagram illustrating the attributes of the binding process 112 in some embodiments.

Once a computing device 103 is issued a binding bundle 114 by a license server 108 (see FIG. 8), it can proceed with the binding process 112 which involves reassembling 155 the unbound content 110 into bound content 156 by using the individualized and hardware sensitive reassembly rules 143 (see FIG. 8) that were issued within binding bundle 114. Furthermore, binding process 112 will also store the individualized and hardware sensitive File Allocation Table 144 (see FIG. 8), the individualized and hardware sensitive binaries 145 (see FIG. 8) and the cryptographic keys 146 (see FIG. 8) within a black box secure storage mechanism 115. There is no requirement for specifying what the said black box secure storage mechanism 115 should be since different computing devices 103 and different operating systems running on those computing devices 103 may offer varying capabilities relating to the secure storage of data.

For the purpose of the present embodiment, black box secure storage 115 is defined as a permanent storage mechanism such as, but not limited to, a file on computer hard disk, which is capable of storing information such that it can only be accessed by a specific software application on a specific computing device 103. As such, the information stored within the black box secure storage 115 could not be used on a foreign computing device 103 nor could it be accessed by any foreign software application.

Persons skilled in the art may perceive that even though there is herein a reference to the binding bundle 114 being issued for a specific computing device 103, on some embodiments of the invention, the binding bundle 114 may further be associated with a specific user for a specific computing device 103. Moreover, further embodiments of the invention may associate a binding bundle 114 with mechanisms other than a computer device 103 or a user.

The binding process 112 includes the reassembly process 155 which is explained in higher detail in FIG. 10.

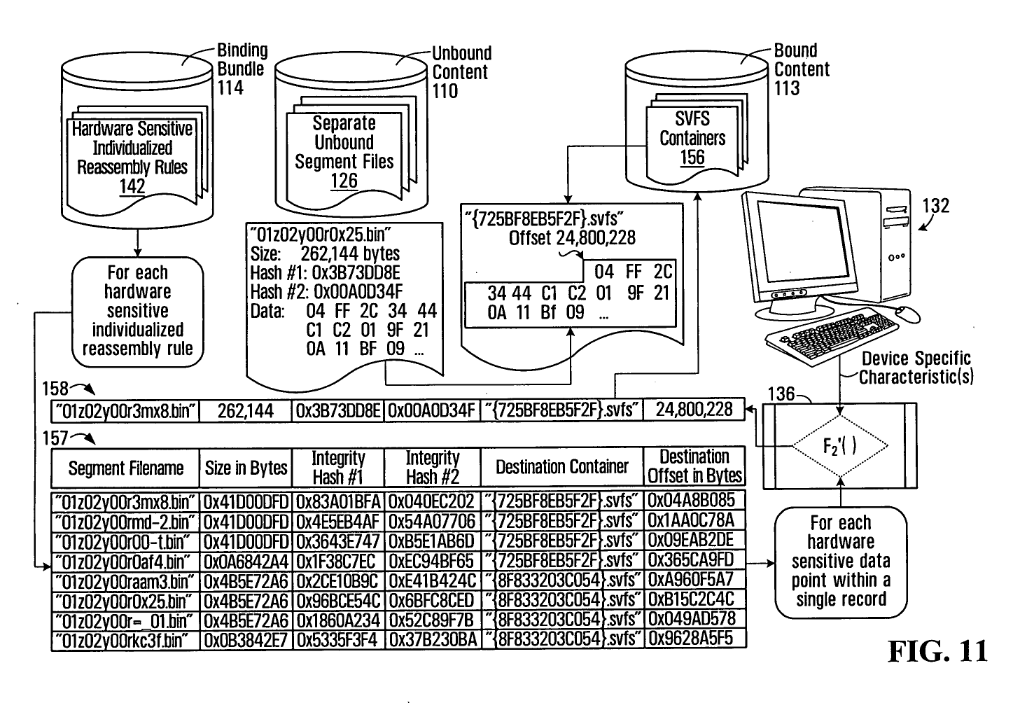

FIG. 11 is a schematic diagram illustrating the core functionality of the reassembly process 155.

Reassembly process 155 is a key component of the invention. In order to better understand this process 155, the concept and functionality of SVFS containers 156 must be described.

A file system is defined as a system that manages all aspects of storage, searching and retrieval of computer files stored within a storage device which may or may not consist of a hard disk drive 27. File systems usually have some form of file allocation table required to track where and how each computer file is stored within the file system storage device. Examples of such file systems include FAT (File Allocation Table) and NTFS (NT File System) which are widely used with Microsoft Windows operating systems.

For the purpose of the processes described herein, SVFS container 156 is a computer file which embodies the role of a file system storage device. In some embodiments, the invention allows for several separate SVFS containers 156 to exist at once, something that is analogous to a computing device 103 being equipped with several hard disk drives 27 (see FIG. 1).

The role of the reassembly process 155 is to generate one or more SVFS containers 156 which consist of an aggregate of several unbound segment files 126. The binding bundle 114 contains hardware sensitive individualized reassembly rules 142 which act as a set of instructions on how each separate unbound segment file 126 should be reassembled within a specific SVFS container 156. An algorithm F₂′( ), in conjunction with one or more device specific characteristic 132, translates each hardware sensitive data point within each reassembly rule 157 back to their original values 158 in order to find out where each separate unbound segment file 126 belongs within a specific SVFS container 156.

Once the reassembly process 155 is complete, the runtime process 118 (see FIG. 1) will be able to use the File Allocation Table 144 which is stored within a black box secure storage 115 (see FIG. 1) in order to access the bound content 113 such that the original digital content 105 & 117 can be reconstituted and as such, rendered by the runtime process 118.

FIG. 12 is a detailed diagram illustrating one example of how the runtime process 118 uses the File Allocation Table 144 which is stored within a black box secure storage 115 (see FIG. 1) in order to access the bound content 113 such that the original content 117 (which is equivalent to the original digital content 105) may be reconstituted and thereof, rendered.

The runtime process 118 (see FIG. 2) denotes an application program 36 (see FIG. 1) which has been loaded in system memory 22 (see FIG. 1) and is actively being executed by the processor unit 21 (see FIG. 1).

An application program 36 should contain the appropriate DRM executable instructions which are capable of accessing both the black box secure storage 115 (see FIG. 2) and thereof, the bound content 113. Whether these executable instructions already exist within the application program 36 or are injected into the runtime process 118 once it has been loaded into memory depends on the specific embodiment. The goal of the DRM executable instructions is to replace the standard OS 35 (see FIG. 2) API calls relating to the file system with new API calls who can not only manage regular files within the regular file system of the OS 35 but can also manage the protected files which are stored within the bound content 113 (i.e. Secure Virtual File System).

Once loaded and running, the runtime process 118 (see FIG. 2) will execute a file system related function call that requires access to the file system. FIG. 11 illustrates how one such function call would be processed.

A function call to OpenFile(“Texture.jpg”) 159 is made by a runtime process 118 (see FIG. 2). The null terminated string “Texture.jpg” 160 is converted into a non-reversible hardware sensitive 64 bit hash value by a function F₁( ) 130, using device specific characteristics 132, such that the resulting 64 bit hash value of 0x04D02BFF255FE031A 161 is now used by the new function call OpenFileWithHash(0x04D02BFF255FE031A) 162 in order to access the File Allocation Table 144. The goal of OpenFileWithHash( . . . ) 162 is to assemble each instance of records within the File Allocation Table 144 that belong to the file identified by the 64 bit hash value of 0x04D02BFF255FE031A 161. As the illustrative example of FIG. 11, the file “Texture.jpg” 160 which translates to 0x04D02BFF255FE031A 161 is made up of four segments whose records are found at index positions 42, 711, 1123 and 1124 within the File Allocation Table 144. Since each record within the File Allocation Table 144 contains one or more hardware sensitive data point, each hardware sensitive data point within each record needs to be converted by a function F₂′( ) 136 such that the original values of each hardware sensitive data point is recovered. This conversion only occurs at runtime such that the resulting records 164 only exist within a volatile storage environment (i.e. RAM 25).

Once the runtime process 118 has aggregated all four records corresponding to each segment, it can proceed to reassemble the original content 117 in computer memory (i.e. RAM 25) by fetching the data of each segment within their respective SVFS container 156 and writing the said segment data within a buffer 117 in computer memory (i.e. RAM 25). The said memory buffer 117 will end up containing a identical binary image of the original digital content 105 as created by the author 101 (see FIG. 1). As such, the runtime process 118 can thereof use the memory buffer 117 to correctly render the original digital content 105.

In some embodiments, the following benefits can be achieved.

Optimal distributed network downloading. Since the protected content is distributed in the form of unbound segments (i.e. small files) which are identical for all users, the distributed content is particularly well suited for massively parallel distributed network or peer to peer distribution which is the most cost effective and efficient way to distribute digital content over the Internet (much more efficient that streaming downloads and direct downloads).

Support for multiple simultaneous versions. As a result of the creation of a SVFS, some embodiments could be designed to allow several different versions of the same digital content to exist within the same SVFS at the same time.

Support for third party digital content. It is desirable in computer games that there be an ability to modify the game by fans and third party digital content providers. Such modifications usually consist of adding new content (i.e. new levels, new weapons, new “skins”, etc.) to an already published computer game. In some embodiments, any third party digital content can be protected.

FIGS. 1 to 12 provide a specific example of a computer system or elements of a computer system that could be used to implement embodiments of the invention. It is to be understood that embodiments of the invention can be implemented with computer systems having architectures that are different than the specific example, but that operate in a manner consistent with the implementation of the embodiments as described herein.

Numerous modifications and variations of the present invention are possible in light of the above teachings. It is therefore to be understood that within the scope of the appended claims, the invention may be practised otherwise than as specifically described herein.

1. A method for protecting digital content from unauthorized use comprising the steps of:
fragmenting the digital content into a plurality of plain text segments; to form unbound content so that the rendering context of each plain text segment in the digital content is removed; and
generating mapping information containing information as to how the plain text segments relate to each other as per their original location within the digital content.

2. A method as claimed in claim 1 further including the step of:
distributing the mapping information to a license server.

3. A method as claimed in claim 1 further including the step of:
distributing the plain text segments to an end user computing device without copy protection.

4. A method as claimed in claim 3 whereby the plain text segments are distributed to the end user computing device via one of CD media, DVD media, streaming online distribution, direct download, memory stick, and peer to peer distribution.

5. A method as claimed in claim 1 further comprising the step of:
augmenting the plain text segments with metadata.

6. A method as claimed in claim 5 whereby the metadata comprises one or more of authentication rules, distribution rules, content data, and market data.

7. A method as claimed in claim 1 further comprising the steps of:
prior to the fragmenting step, destroying part of the digital content; and,
augmenting the mapping information with data associated with the destroyed part of the digital content.

8. A method as claimed in claim 1 wherein the digital content includes at least one of e-books, books, documents, music, audio information, multimedia presentations and video information.

9. A method as claimed in claim 3 further comprising the step of:
authenticating the end user computing device.

10. A method as claimed in claim 9 in which upon authentication, the end user computing device is delivered an authorization identifier.

11. A method as claimed in claim 10 wherein the authorization identifier is digitally signed or asymmetrically encrypted.

12. A method as claimed in claim 10 further comprising:
using the authorization identifier to access to the license server;
issuing the end user computing device reassembly rules for the plain text segments, and a file allocation table containing the rendering context for each plain text segment, and
using the reassembly rules to bind the unbound content to the end user computing device thereby forming bound content.

13. A method as claimed in claim 12 further comprising the step of:
issuing the end user computing device one or more cryptographic keys.

14. A method as claimed in claim 12 further comprising the step of:
issuing the end user computing device executable code for accessing the bound content at runtime.

15. A method as claimed in claim 12 wherein the plain text segments are bound to the end user computing device using one or more Secure Virtual File System (“SVFS”) containers which store, in the aggregate, all of the bound content.

16. A method as claimed in claim 15 whereby the file allocation table is used to access the bound content such that the original digital content is reconstituted for rendering by an application program at runtime.

17. A method as claimed in claim 16 whereby said application program or related binaries contains digital rights management executable instructions adapted to access the file allocation table and the bound content.

18. A method as claimed in claim 13 further comprising the step of:
using the one or more cryptographic keys to decrypt the reassembly rules, file allocation table, and one or more binary files.

19. A method as claimed in claim 18 whereby an application program is configured to use a decryption key to decrypt said reassembly rules, file allocation table, and one or more binary files and utilize said bound content.

20. A method of managing digital rights of digital content at an end user computing device comprising the steps of:
receiving digital content in the form of a plurality of plain text segments without a rendering content;
receiving an end user computing device reassembly rules for the plain text segments, and a file allocation table containing rendering context for each plain text segment, and
using the reassembly rules to uniquely bind the plain text segments to the end user computing device thereby forming bound content.

21. A method as claimed in claim 20 further comprising the step of:
receiving one or more cryptographic keys and using the one or more cryptographic keys to decrypt the reassembly rules, file allocation table, and one or more binary files.

22. A method as claimed in claim 20 further comprising the step of:
receiving executable code for accessing the bound content at runtime.

23. A method as claimed in claim 20 wherein the plain text segments are bound to the end user computing device using one or more secure virtual file system containers (i.e. computer files) which store, in the aggregate, all of the bound content.

24. A method as claimed in claim 20 whereby the file allocation table is used to access the bound content such that the digital content is reconstituted for rendering by an application program.

25. A method as claimed in claim 24 whereby said application program or associated binaries contains digital rights management executable instructions adapted to access the file allocation table and the bound content.

26. A method as claimed in claim 24 whereby the application program is configured to use a decryption key to decrypt said reassembly rules, file allocation table, and one or more binary files and utilize said bound content.

27. A computer-readable medium having computer-executable instructions for carrying out the steps recited in claim 1.

28. A method as claimed in claim 12 wherein the reassembly rules are comprised of hardware sensitive data “A” such that the actual relevant data “B” required to bind the unbound content to the end user computing device is derived from computing device specific settings “C” using a function “F” such that F(A, C)=B.

29. A method as claimed in claim 12 wherein the reassembly rules contain information about how the plain text segments are to be reassembled into one or more SVFS containers.

30. A method as claimed in claim 12 wherein the reassembly rules and file allocation table are unique for each end user computing device.
